(19) United States
(12) Patent Application Publication
(10) Pub. No.: US 2011/0062063 A1
(43) Pub. Date: Mar. 17, 2011

(54) POWER RECOVERY APPARATUS

(76) Inventors: Ryoichi TAKAHASHI, Yokosuka-shi (JP); Fumihide Nagashima, Yokohama-shi (JP); Koichi Matsui, Tokyo (JP); Futoshi Kurokawa, Tachikawa-shi (JP); Hideaki Yamagata, Urayasu-shi (JP)

(21) Appl. No.: 12/862,300

(22) Filed: Aug. 24, 2010

(30) Foreign Application Priority Data
Sep. 11, 2009 (JP) 2009-210920

(51) Int. Cl. B01D 61/06; C02F 1/44

(52) U.S. Cl. 210/143; 210/251

(57) ABSTRACT

According to one embodiment, a power recovery apparatus used in a desalination apparatus including a reverse osmosis membrane which extracts fresh water from seawater and ejects concentrated water includes a pressure conversion section and a seawater supply section to collect energy of the concentrated water. The pressure conversion section includes a movable part dividing inside of the conversion section into first and second spaces, moves the movable part by causing the first space to receive the concentrated water, and pushes out seawater filled in the second space by the movable part to output the seawater. The seawater supply section merges the seawater from the pressure conversion section with the seawater supplied to the reverse osmosis membrane.

### CROSS-REFERENCE TO RELATED APPLICATIONS

This application is based upon and claims the benefit of priority from Japanese Patent Application No. 2009-210920, filed Sep. 11, 2009; the entire contents of which are incorporated herein by reference.

### FIELD

Embodiments described herein relate generally to a power recovery apparatus.

### BACKGROUND

A desalination apparatus supplies a reverse osmosis membrane (hereinafter referred to as a RO membrane) with seawater having a higher pressure than a reverse osmosis pressure. The desalination apparatus allows seawater to permeate the reverse osmosis membrane and thereby extracts fresh water from the seawater by filtering out salt. Further, the desalination apparatus ejects remaining seawater as highly-concentrated salt water (brine). At this time, the highly-concentrated salt water is ejected maintained at a high pressure, and therefore has high pressure energy. In recent years, aiming for energy saving, power recovery apparatuses are mounted on desalination apparatuses (see, Jpn. Pat. Appln. KOKAI Publication No. 2004-81913 and No. 2001-46842, for example). Power recovery apparatuses collect highly-concentrated salt water at a high pressure, and utilize pressure energy of the highly-concentrated salt water to press seawater.

Conventional power recovery apparatuses require a boost pump to further boost a pressure of seawater which has been pressed by using pressure energy. This is because the pressure of the seawater which has been pressed by using the pressure energy need be further boosted to a pressure of seawater to be supplied to the RO membrane. However, the boost pump is a factor which causes various problems.

Firstly, since the boost pump boosts up the pressure of seawater to a very high pressure, the boost pump need be constituted by a thick member so that the pump may not break down due to its own internal pressure. A problem therefore occurs in that pump efficiency extremely decreases and power consumption of the boost pump increases accordingly.

Further, the boost pump has a high internal pressure, which often causes leakages of inner fluids. Therefore, the working ratio of the apparatus decreases and causes a problem that clear water cannot stably supplied.

Further, a large number of pumps, such as water pumps, high pressure pumps, and boost pumps are installed in desalination plants. Since pumps require periodical maintenance, a large number of pumps installed in a plant cause increase in costs and labor for maintenance services.

Further, the boost pumps each are constituted by a thick member as described above, and are therefore relatively expensive components in plants. The boost pumps are therefore factors which increase construction costs of plants.

A power recovery apparatus described in one of the foregoing publications includes two RO membranes. Proposed herein is a technique to exclude installation of a boost pump, e.g., highly-concentrated salt water ejected from a first RO membranes is filtered by a second RO membranes. However, the RO membranes are expensive components, and the configuration described above is therefore a factor which may increase plant construction costs.

### BRIEF DESCRIPTION OF THE DRAWINGS

FIG. 1 is a block diagram representing a configuration of a desalination plant including a power recovery apparatus according to the first embodiment;

FIG. 2 represents a configuration of the power recovery apparatus in FIG. 1 in a first state during operation of the power recovery apparatus;

FIG. 3 represents a configuration of the power recovery apparatus in FIG. 1 in a second state during operation of the power recovery apparatus;

FIG. 4 illustrates a configuration of converters in FIG. 2 and FIG. 3;

FIG. 5 illustrates a configuration of a conventional power recovery apparatus;

FIG. 6 is a table listing specifications of a desalination apparatus used in numerical simulations;

FIG. 7 is a table listing results of a numerical simulation of a desalination apparatus including no power recovery apparatus;

FIG. 8 is a table listing results of a numerical simulation of a desalination apparatus including the power recovery apparatus in FIG. 1;

FIG. 9 is a table listing results of a numerical simulation of a desalination apparatus including the power recovery apparatus in FIG. 5;

FIG. 10 represents the first modification to the power recovery apparatus in FIG. 2;

FIG. 11 represents the second modification to the power recovery apparatus in FIG. 2;

FIG. 12 represents the third modification to the power recovery apparatus in FIG. 2;

FIG. 13 is a block diagram representing a configuration of a power recovery apparatus according to the second embodiment;

FIG. 14 is a block diagram representing a configuration of a power recovery apparatus according to the third embodiment;

FIG. 15 illustrates a crankshaft in FIG. 14;

FIG. 16 is a block diagram representing a configuration of a power recovery apparatus according to the fourth embodiment; and

FIG. 17 illustrates a structure of rotary actuators in FIG. 16.

### DETAILED DESCRIPTION

In general, according to one embodiment, a power recovery apparatus is used in a desalination apparatus. The desalination apparatus boosts a first pressure of seawater to a second pressure by a high-pressure pump, and extracts fresh water from the seawater at the second pressure and ejects concentrated water at a third pressure by a reverse osmosis membrane. The concentrated water at the third pressure is supplied to the power recovery apparatus. The power recovery apparatus collects energy of the concentrated water at the third pressure. The power recovery apparatus includes a pressure conversion section and a seawater supply section. The pressure conversion section includes a movable part dividing inside of the conversion section into first and second spaces, moves the movable part by causing the first space to receive the concentrated water at the third pressure from the reverse osmosis membrane, and pushes out seawater filled in the second space, in accordance with movement of the movable part, to output the seawater at the second pressure. The seawater supply section merges the seawater from the pressure conversion section with the seawater from the high-pressure pump.

### First Embodiment

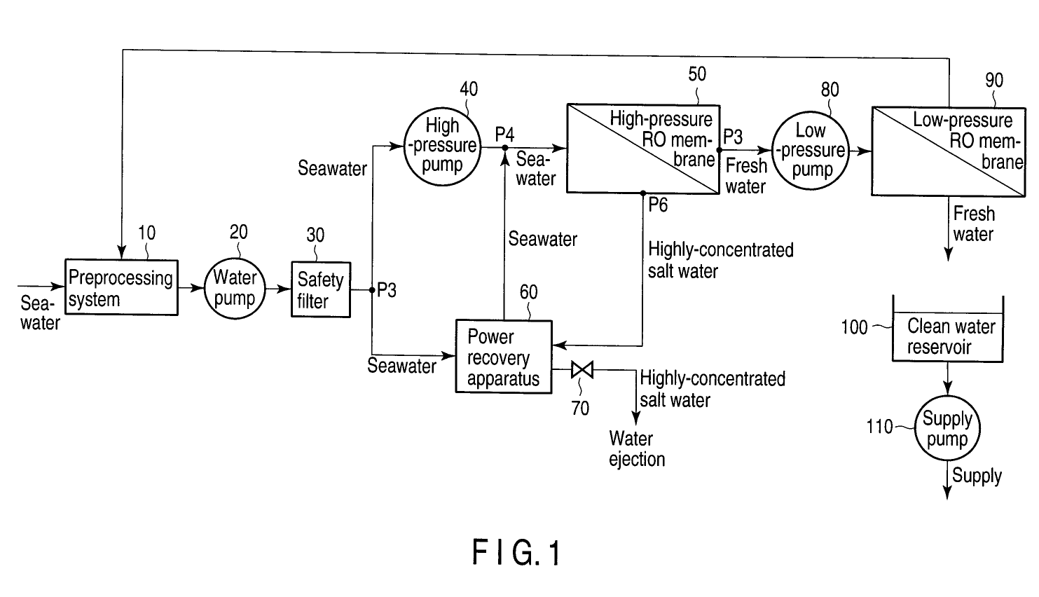

FIG. 1 is a block diagram representing a configuration of a desalination plant including a power recovery apparatus 60 according to the first embodiment. In the desalination plant in FIG. 1, seawater which is drawn up is subjected to a chemical treatment by a preprocessing system 10 and is fed to a safety filter 30 by a water pump 20. Seawater which has passed through the safety filter 30 is supplied, on one end, to a high pressure pump 40 and, on another end, supplied to the power recovery apparatus 60. At this time, a pressure P3 of seawater output from the safety filter 30 is about 0.2 MPa.

The high pressure pump 40 boosts a pressure of the supplied seawater and outputs the boosted seawater to a high-pressure RO membrane 50. At this time, a pressure P4 after the boost is representatively 6.0 MPa although the pressure P4 after the boost varies depending on the type of the high-pressure RO membrane 50.

The high-pressure RO membrane 50 filters the seawater from the high pressure pump 40. When the high-pressure RO membrane 50 has a recovery rate of 40%, 40% of seawater flowing into the high-pressure RO membrane 50 is extracted as fresh water and 60% of seawater is ejected as highly-concentrated salt water. The fresh water from the high-pressure RO membrane 50 is supplied to a low-pressure pump 80, and the highly-concentrated salt water is supplied to the power recovery apparatus 60. At this time, the pressure of the fresh water decreases to about 0.2 MPa (=P3). However, a pressure P6 of the highly-concentrated salt water is about 5.8 MPa.

The fresh water from the high-pressure RO membrane 50 is pressed again by the low-pressure pump 80, and permeates the low-pressure RO membrane 90, thereby filtering out contained boron. Further, the fresh water which has permeated the low-pressure RO membrane 90 is subjected to a chemical treatment in a clear water reservoir 100, and is then supplied as clear water from a supply pump 110 to homes, etc.

The power recovery apparatus 60 boosts and outputs seawater from the safety filter 30 by using pressure energy which the highly-concentrated salt water has internally. Seawater from the power recovery apparatus 60 is merged with seawater from the high pressure pump 40 and is supplied together to the high-pressure RO membrane 50.

An end of a valve 70 is open to air. An ejection flow rate of highly-concentrated salt water from which pressure energy has been collected by the power recovery apparatus 60 is controlled by the valve 70.

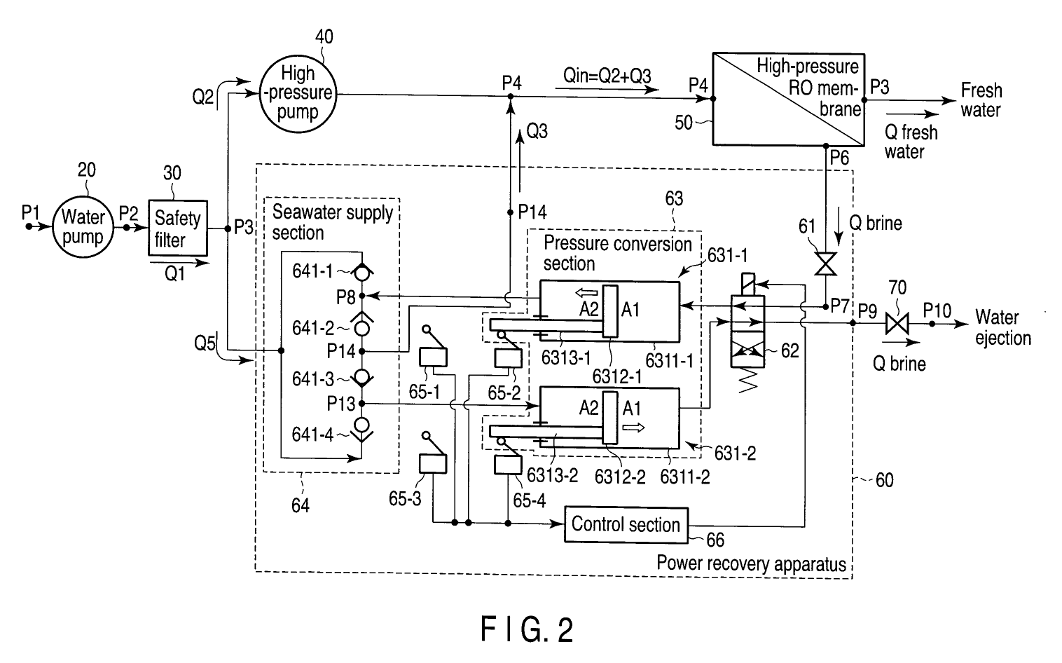

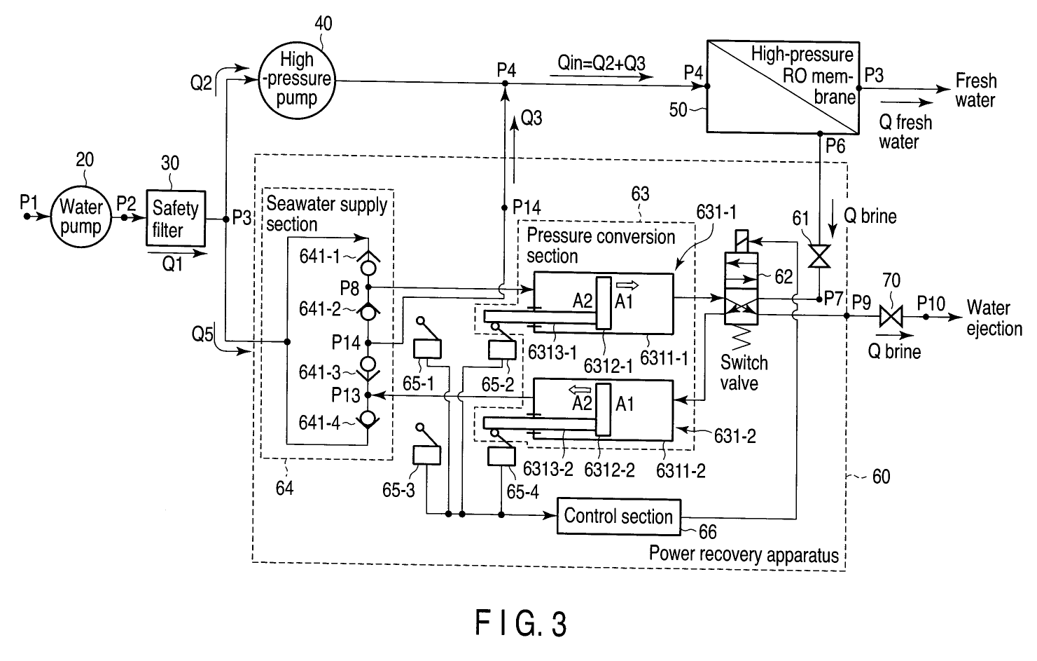

FIG. 2 and FIG. 3 are schematic diagrams each representing a configuration of the power recovery apparatus 60 according to the first embodiment, in operating states of the power recovery apparatus 60.

At first, the configuration of the power recovery apparatus 60 will be described with reference to FIG. 2. The power recovery apparatus 60 in FIG. 2 includes a valve 61, a 4-port switch valve 62, a pressure conversion section 63, a seawater supply section 64, rod position detection sections 65-1 to 65-4, and a control section 66.

The valve 61 controls a pressure of highly-concentrated salt water supplied to the 4-port switch valve 62 by limiting a flow of highly-concentrated salt water output from the high-pressure RO membrane 50. If the high-pressure RO membrane 50 works for a long period, the high-pressure RO membrane 50 is clogged, and a pressure P6 of the highly-concentrated salt water from the high-pressure RO membrane 50 is reduced. The valve 61 is utilized for adjusting the reduction of the pressure P6. Therefore, a pressure P14 of seawater from the power recovery apparatus 60 equals to a pressure P4 of seawater from the high pressure pump 40.

The 4-port switch valve 62 switches directions of flow of highly-concentrated salt water into a pressure conversion section 63 and ejection from the pressure conversion section 63. The 4-port switch valve 62 switches the directions of flow-in and ejection of highly-concentrated salt water in accordance with a switch instruction from the control section 66. A method for switching the 4-port switch valve may be of a pneumatic type, a hydraulic water type, a hydraulic oil type, and a solenoid coil type. Available as a water pressure source is highly-concentrated salt water, seawater from the water pump 20, or high-pressure salt water from the high pressure pump 40.

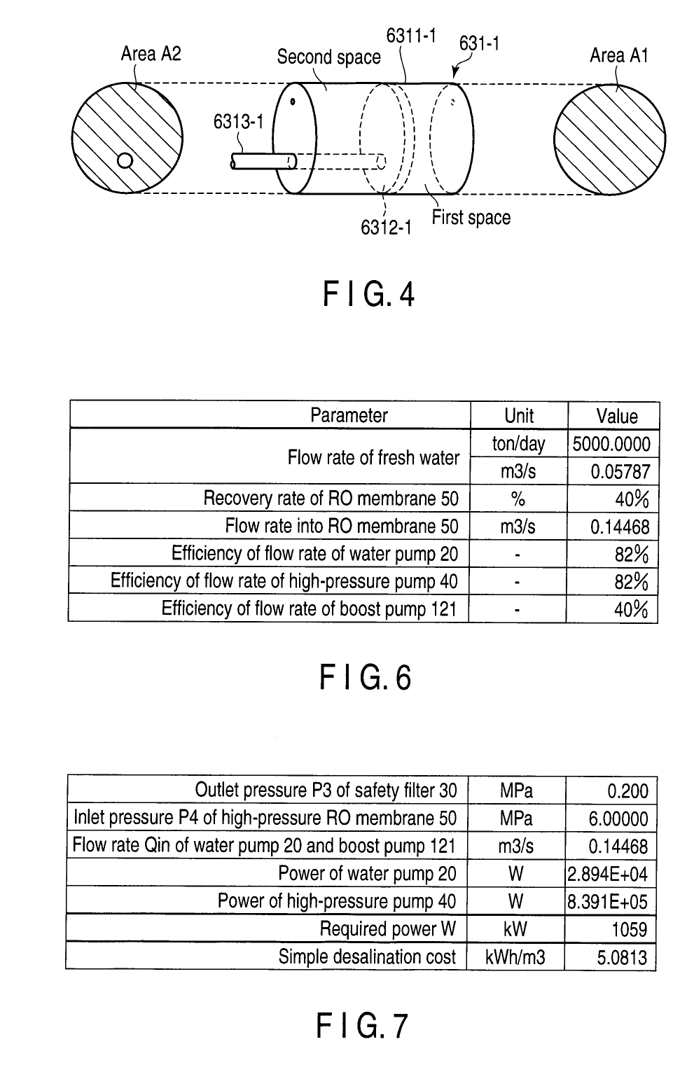

The pressure conversion section 63 includes converters 631-1 and 631-2. FIG. 4 is a schematic view illustrating a configuration of the converters 631-1 and 631-2. The converters 631-1 and 631-2 have the same structures as each other. Therefore, only the converter 631-1 will be described with reference to FIG. 4. The converter 631-1 in FIG. 4 includes a cylinder 6311-1, a piston 6312-1, and a rod 6313-1.

The cylinder 6311-1 includes three holes and forms a sealed space.

The piston 6312-1 is positioned inside the cylinder 6311-1, and divides the sealed space into first and second spaces, with a seal material provided between the piston 6312-1 and the cylinder 6311-1. The first space is supplied with highly-concentrated salt water, and the second space is supplied with seawater.

The rod 6313-1 has an end bonded to the piston 6312-1 from the side of the second space, and another end protruding outside through a hole in the cylinder 6311-1. A seal material is attached to an edge of the hole. Since the rod 6313-1 is bonded to the piston 6312-1 from the side of the second space, an area A1 where the piston 6312-1 faces the first space differs from an area A2 where the piston 6312-1 faces the second space. Here, a relationship between the areas A1 and A2 is preset based on the pressure P6 of highly-concentrated salt water from the high-pressure RO membrane 50, the pressure P4 of seawater from the high pressure pump 40, friction between the cylinder 6311-1 and the piston 6312-1, and friction between the cylinder 6311-1 and the rod 6313-1.

The seawater supply section 64 includes check valves 641-1 to 641-4. The check valves 641-1 to 641-4 each independently open/close in accordance with environmental pressure differences. In this manner, seawater is supplied from the power recovery apparatus 60 to outside or to the pressure conversion section 63.

The detection sections 65-1 and 65-2 are to detect positions of the rod 6313-1 protruding from the converter 631-1. The detection section 65-1 is located at a position where the rod 6313-1 can be detected when the piston 6312-1 comes close to the left end of the cylinder 6311-1. The detection section 65-2 is located at a position where the rod 6313-1 is not detected when the piston 6312-1 comes close to the right end of the cylinder 6311-1. The detection sections 65-1 and 65-2 output detection signals to the control section 66 when the rod 6313-1 is detected and when the rod 6313-1 is not detected, respectively. In this manner, the positions of the piston 6312-1 in the cylinder 6311-1 can be grasped. Detection sections 65-3 and 65-4 have the same configurations as the detection sections 65-1 and 65-2, and detect positions of a rod 6313-2 protruding from the converter 631-2. The detection sections 65-3 and 65-4 output detection signals to the control section 66 when the rod 6313-2 is detected and is not detected, respectively. In this manner, the positions of the piston 6312-2 in the cylinder 6311-2 can be grasped. A detection method for the detection sections 65-1 to 65-4 may be of a mechanical, electric, or optical type. Although the present embodiment is configured to output the detection signals to the control section 66, movement of the rods may alternatively be mechanically transmitted to the 4-port switch valve 62.

The control section 66 outputs a switch instruction to the 4-port switch valve 62 in accordance with detection signals from the detection sections 65-1 to 65-4. That is, when the control section 66 receives detection signals from the detection sections 65-1 and 65-4, the control section 66 determines that the piston 6312-1 is positioned close to the left end of the cylinder 6311-1 and that the piston 6312-2 is positioned close to the right end of the cylinder 6311-2. Further, the control section 66 outputs a switch instruction to make the converter 631-1 eject highly-concentrated salt water and to make the converter 631-2 be supplied with highly-concentrated salt water. Otherwise, when the control section 66 receives detection signals from the detection sections 65-2 and 65-3, the control section 66 determines that the piston 6312-1 is positioned close to the right end of the cylinder 6311-1 and that the piston 6312-2 is positioned close to the left end of the cylinder 6311-2. Further, the control section 66 outputs a switch instruction to the 4-port switch valve 62 to make the converter 631-1 be supplied with highly-concentrated salt water and to make the converter 631-2 eject highly-concentrated salt water.

Next, operation of the power recovery apparatus 60 configured as described above will be described.

The power recovery apparatus 60 in FIG. 2 is in a state in which the converter 631-1 is supplied with highly-concentrated salt water while highly-concentrated salt water is ejected from the converter 631-2.

Seawater from the safety filter 30 is supplied to a high-pressure pump 40 at 0.2 MPa (=P3), and is supplied to the second space of the converter 631-2 through the check valve 641-4.

Seawater boosted to 6.0 MPa (=P4) by the high pressure pump 40 is merged with seawater from the power recovery apparatus 60, and is supplied together to the high-pressure RO membrane 50. At this time, the seawater from the power recovery apparatus 60 has been ejected from the second space of the converter 631-1 and passed through the check valve 641-2. The high-pressure RO membrane 50 outputs fresh water and highly-concentrated salt water.

The highly-concentrated salt water ejected from the high-pressure RO membrane 50 passes through the valve 61 and 4-port switch valve 62 and flows into the first space of the converter 631-1. At this time, the second space of the converter 631-1 is filled with seawater. The highly-concentrated salt water moves the piston 6312-1 in the cylinder 6311-1 in a direction toward the second space, and ejects seawater in the second space while pressing the seawater.

An area where the piston 6312-1 faces the first space is A1, and an area where the piston 6312-1 faces the second space is A2. Hence, a pressure P8 of the seawater which is ejected from the second space of the cylinder 6311-1 is expressed as P8=P7*(A1/A2), using a pressure P7 of highly-concentrated salt water from the 4-port switch valve 62. Accordingly, the pressure P8 is substantially equal to or slightly higher than the pressure P4.

States of the check valves 641-1 to 641-4 in FIG. 2 will now be described below.

Since pressure P8>pressure P3, the check valve 641-1 is closed. Since pressure P8>pressure P14, the check valve 641-2 is opened. A pressure difference between the pressure P8 and pressure P14 can be considered to be a pressure loss when seawater passes through the check valve 641-2.

Further, since pressure P14>pressure P13, the check valve 641-3 is closed. Further, as an end of the valve 70 is open to air, a gauge pressure of the second space of the cylinder 6311-2 is therefore substantially zero. That is, P13 is a small pressure. Therefore, P3>P13 is given, and the check valve 641-4 is opened.

Seawater from the safety filter 30 passes through the check valve 641-4 and flows into the second space of the converter 631-2. At this time, the first space of the converter 631-2 is filled with highly-concentrated salt water. Since an end of the valve 70 is open to air, a gauge pressure of the first space of the converter 631-2 is substantially zero. Seawater which has passed through the check valve 641-4 has a pressure of 0.2 MPa, and moves the piston 6312-2 in the cylinder 6311-2 toward the first space. The piston 6312-2 moves toward the first space, thereby ejecting highly-concentrated salt water in the first space out through the 4-port switch valve 62 and the valve 70.

When the operation as described above is continued, the piston 6312-1 moves close to the left end inside the cylinder 6311-1 and the piston 6312-2 moves close to the right end inside the cylinder 6311-2. Then, the detection sections 65-1 detects the rod 6313-1 to come into contact, and the detection sections 65-4 detects the rod 6313-2 to go out of contact. Accordingly, detection signals are output from the detection sections 65-1 and 65-4 to the control section 66. The control section 66 receives the detection signals from the detection sections 65-1 and 65-4, and then issues a switch instruction to the 4-port switch valve 62 so as to switch directions of flow-in and ejection of highly-concentrated salt water. When flow-in and ejection of highly-concentrated salt water are switched over, the power recovery apparatus 60 enters into the state represented in FIG. 3.

In the power recovery apparatus 60 in FIG. 3, highly-concentrated salt water is supplied to the converter 631-2 and is ejected from the converter 631-1.

The highly-concentrated salt water ejected from the high-pressure RO membrane 50 passes through the valve 61 and 4-port switch valve 62 and flows into the first space of the converter 631-2. At this time, the second space of the converter 631-2 is filled with seawater. Highly-concentrated salt water moves the piston 6312-2 in the cylinder 6311-2 toward the second space, and presses and ejects seawater in the second space.

An area where the piston 6312-2 faces the first space is A1, and an area where the piston 6312-2 faces the second space is A2. Accordingly, a pressure P13 of the seawater which is ejected from the second space of the cylinder 6311-2 is expressed as P13=P7*(A1/A2), using a pressure P7 of highly-concentrated salt water from the 4-port switch valve 62. Accordingly, the pressure P13 is substantially equal to or slightly higher than the pressure P4.

States of the check valves 641-1 to 641-4 in FIG. 3 will now be described below.

Since pressure P13>pressure P3, the check valve 641-1 is closed. Since pressure P13>pressure P14, the check valve 641-2 is opened. A pressure difference between the pressure P13 and pressure P14 can be considered to be a pressure loss when seawater passes through the check valve 641-3.

Further, since pressure P14>pressure P8, the check valve 641-2 is closed. Further, as an end of the valve 70 is open to air, a gauge pressure of the second space of the cylinder 6311-1 is therefore substantially zero. That is, P8 is a small pressure. Therefore, P3>P8 is given, and the check valve 641-1 is opened.

Seawater from the safety filter 30 passes through the check valve 641-1 and flows into the second space of the converter 631-1. At this time, the first space of the converter 631-1 is filled with highly-concentrated salt water. Since an end of the valve 70 is open to air, a gauge pressure of the first space of the converter 631-1 is substantially zero. Seawater which has passed through the check valve 641-1 has a pressure of 0.2 MPa, and moves the piston 6312-1 in the cylinder 6311-1 toward the first space. The piston 6312-1 moves toward the first space, and thereby ejects highly-concentrated salt water in the first space through the 4-port switch valve 62 and the valve 70.

When the operation as described above is continued, the piston 6312-1 moves close to the right end inside the cylinder 6311-1. Then, the detection section 65-3 detects that the rod 6313-2 comes into contact, and the detection section 65-2 detects that the rod 6313-1 goes out of contact. Therefore, detection signals are output from the detection sections 65-2 and 65-3 to the control section 66. The control section 66 receives the detection signals from the detection sections 65-2 and 65-3, and then issues a switch instruction to the 4-port switch valve 62 so as to switch directions of flow-in and ejection of highly-concentrated salt water. When flow-in and ejection of highly-concentrated salt water are switched over, the power recovery apparatus 60 enters again into the state represented in FIG. 2.

In the present embodiment, moving speeds of the piston 6312-1 and piston 6312-2 are made equal to each other by adjusting an opening rate of the valve 70. In this manner, a flow rate of the water pump 20 does not chronographically vary, and stable operation is achieved.

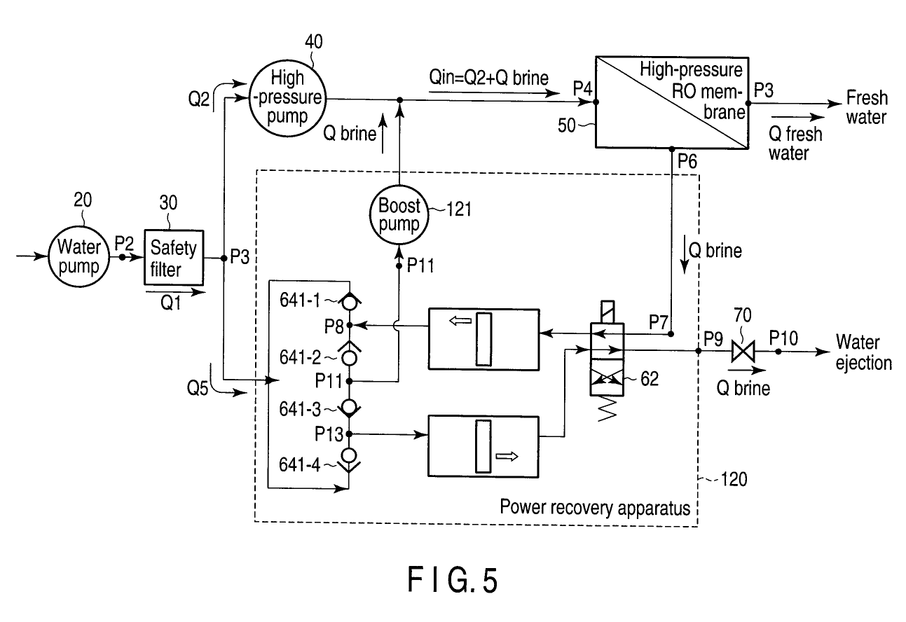

Next, power consumption or, namely, desalination costs when fresh water of 1 m³ is produced will be calculated and compared through numerical simulations between desalination apparatuses in three cases described below. The desalination apparatuses in the three cases are a desalination apparatus including no power recovery apparatus, a desalination apparatus including a conventional power recovery apparatus 120, and a desalination apparatus including a power recovery apparatus 60 according to the present embodiment. FIG. 5 is a schematic diagram representing a configuration of the conventional power recovery apparatus 120.

FIG. 6 lists specifications of the desalination apparatuses used in the numerical simulations. Parameters for the desalination apparatuses are common to the numerical simulations. Further, pump efficiency of the boost pump 121 is set at a low value in consideration of the structure of the boost pump.

FIG. 7 lists results of a numerical simulation of the desalination apparatus including no power recovery apparatus. According to FIG. 7, a desalination cost is 5.08 kWh/m³.

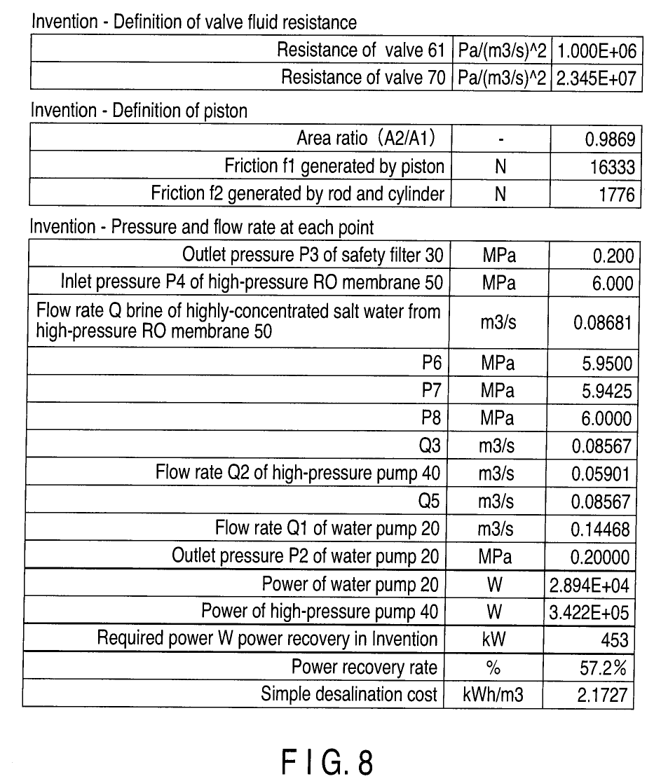

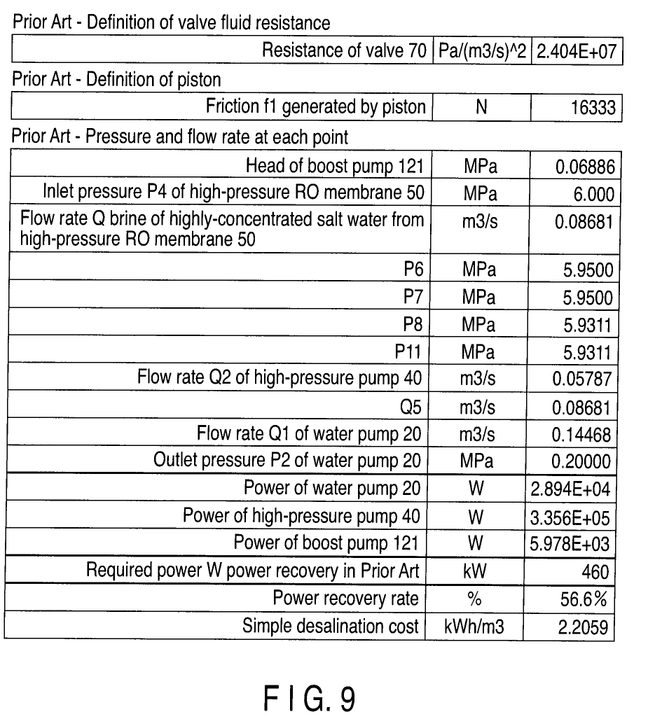

Further, FIG. 8 lists results of a numerical simulation of the desalination apparatus including the power recovery apparatus 60 according to the present embodiment. FIG. 9 lists results of a numerical simulation of the desalination apparatus including a conventional power recovery apparatus 120.

Descriptions below will be made with reference to FIG. 8 and FIG. 9.

The valve 70 requires fluid resistance to some extent from reasons described above. Supposing that a pressure loss occurring in the valve 70 is proportional to a square of a flow rate (m³/s), resistance coefficients as represented in FIG. 8 and FIG. 9 are required. Resistance of the valve 61 is set to be 1*10⁶ Pa/(m³/s)² in FIG. 8.

Further, when a piston moves inside a cylinder, frictional resistance is generated. Such frictional resistance was taken into consideration in the numerical simulations. In FIG. 8 and FIG. 9, frictional resistance between a piston and a cylinder was set to 16333 N. Further, frictional resistance between a rod and a cylinder was set to 1776 N in FIG. 8. Also in FIG. 8, the power recovery apparatus 60 operated as intended, when cylinders were manufactured where an area ratio (A2/A1) between pistons was set to 0.9869.

Results of numerical simulations, i.e., pressures and flow rates at respective sections in FIG. 2 and FIG. 5 were numerical values as listed in FIG. 8 and FIG. 9.

A power W which a pump applies to a fluid is obtained by multiplying a flow rate Q by a pressure P. That is, the power of the water pump 20 in FIG. 8 is calculated by 2.894*10⁴ W, and power of the high-pressure pump 40 is calculated by 3.422*10⁵ W. Further, a power of the water pump 20 in FIG. 9 is calculated by 2.894*10⁴ W, a power of the high-pressure pump 40 is calculated by 3.356*10⁵ W, and a power of the boost pump 121 is calculated by 5.978*10³ W.

Further, a required power W power recovery is obtained by an expression below.

Wpower recovery=ΣΔPiQi/ηi (1)

In the above expression, ΔP is a pump head (Pa), Q is a flow rate (m3/s), and q is a pump efficiency. From the expression (1), the required power in FIG. 8 is 453 kW. Further, the required power in FIG. 9 is 460 kW.

Further, a power recovery rate ξ is calculated by an expression below.

ξ=100(W−Wpower recovery)/W (2)

In the expression above, W is a required power (W) when no power recovery apparatus is included. From the expression (2), a power recovery rate in FIG. 8 is 57.2%, and a power recovery rate in FIG. 9 is 56.6%.

Further, a simple desalination cost γ is calculated by an expression below.

γ=Wpower recovery/Q (3)

In the expression above, Q is a flow rate of fresh water per hour (m³/h). From the expression (3), a simple desalination cost in FIG. 8 is 2.17 kWh/m³, and a simple desalination cost in FIG. 9 is 2.21 kWh/m3.

In this manner, from comparison between FIG. 7, FIG. 8, and FIG. 9, the desalination apparatus including the power recovery apparatus 60 or 120 is found to achieve a far higher power saving effect than the desalination apparatus which includes neither.

Further, the desalination apparatus including the power recovery apparatus 60 according to the present embodiment requires a lower desalination cost than the desalination apparatus including the conventional power recovery apparatus 120. In this manner, the power recovery apparatus 60 according to the present embodiment is found to be capable of effectively collecting pressure energy from highly-concentrated salt water without using the boost pump 121. Further, the lower desalination cost achieved by the desalination apparatus including the power recovery apparatus 60 owes to low pump efficiency of the boost pump 121.

As has been described above, in the first embodiment, rods 6313-1 and 6313-2 are provided so as to penetrate the second spaces of the cylinders 6311-1 and 6311-2 to outside. The penetration to outside causes ends of the rods 6313-1 and 6313-2 to receive a pressure equal to an atmospheric pressure. Therefore, each of areas where the pistons 6312-1 and 6312-2 respectively make contact with the second spaces is smaller than each of areas where the pistons 6312-1 and 6312-2 respectively make contact with the first spaces by each of cross-sectional areas of the rods 6313-1 and 6313-2 vertical to their own lengthwise directions. That is, area A1>area A2. In this manner, the power recovery apparatus 60 is capable of outputting seawater from the second spaces at a pressure equal to a pressure of seawater output from the high-pressure pump 40, by using a pressure of highly-concentrated salt water supplied to the first spaces.

Also in the first embodiment, the positions of the rods 6313-1 and 6313-2 protruding from the cylinders 6311-1 and 6311-2 are detected. Based on detection results thereof, the 4-port switch valve 62 is switched over. In this manner, the positions of the pistons 6312-1 and 6312-2 inside the cylinders 6311-1 and 6311-2 can be correctly and easily recognized.

Therefore, the power recovery apparatus 60 according to the first embodiment can collect pressure energy existing in highly-concentrated salt water, without a boost pump.

Thus, the power recovery apparatus 60 according to the first embodiment requires no boost pump, and can therefore decrease power consumption for desalination. Further, a total number of pumps installed in a plant decreases, and accordingly, maintenance costs and plant construction costs can be reduced.

In addition, the power recovery apparatus 60 can achieve effects as described above by providing the rods in the second spaces of the converters 631-1 and 631-2. Therefore, plant construction costs can be more reduced.

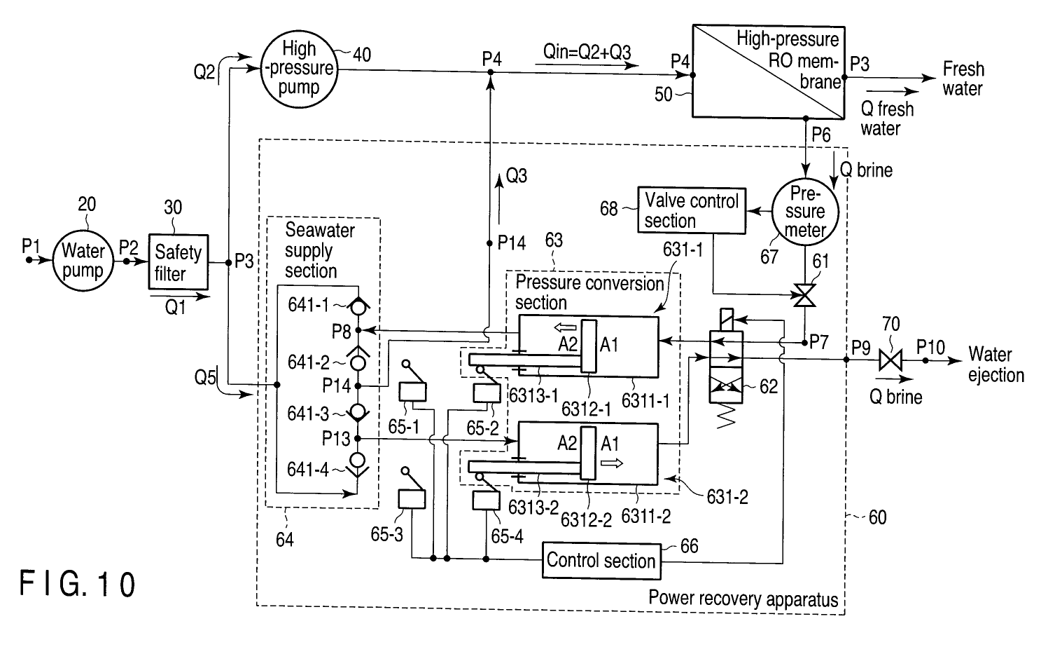

In the first embodiment described above, the power recovery apparatus 60 may have a structure as represented in FIG. 10. The power recovery apparatus 60 in FIG. 10 includes a pressure meter 67 and a valve control section 68. The pressure meter 67 measures a pressure of highly concentrated salt water flowing out of the high-pressure RO membrane 50, and notifies a measurement result thereof to the valve control section 68. The valve control section 68 controls an opening rate of the valve 61. Therefore, a pressure P14 of seawater from the power recovery apparatus 60 equals to a pressure P4 of seawater from the high pressure pump 40.

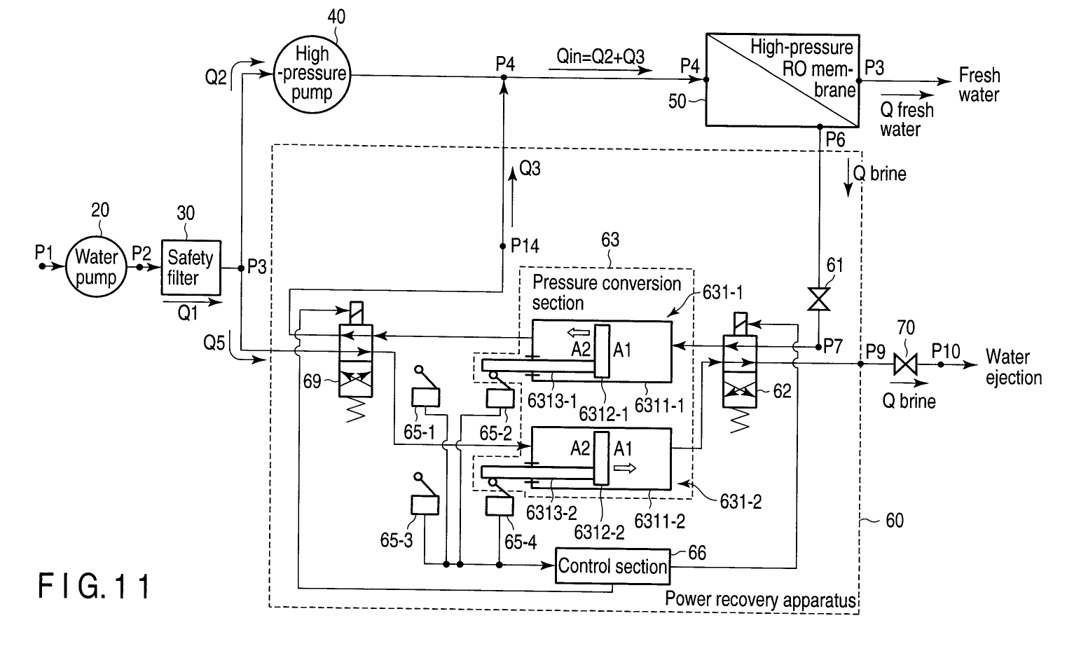

The power recovery apparatus 60 may have a structure as represented in FIG. 11. The power recovery apparatus 60 in FIG. 11 includes a 4-port switch valve 69 instead of the seawater supply section 64. The control section 66 switches the 4-port switch valve 69 at the same time point when the 4-port switch valve 62 is switched.

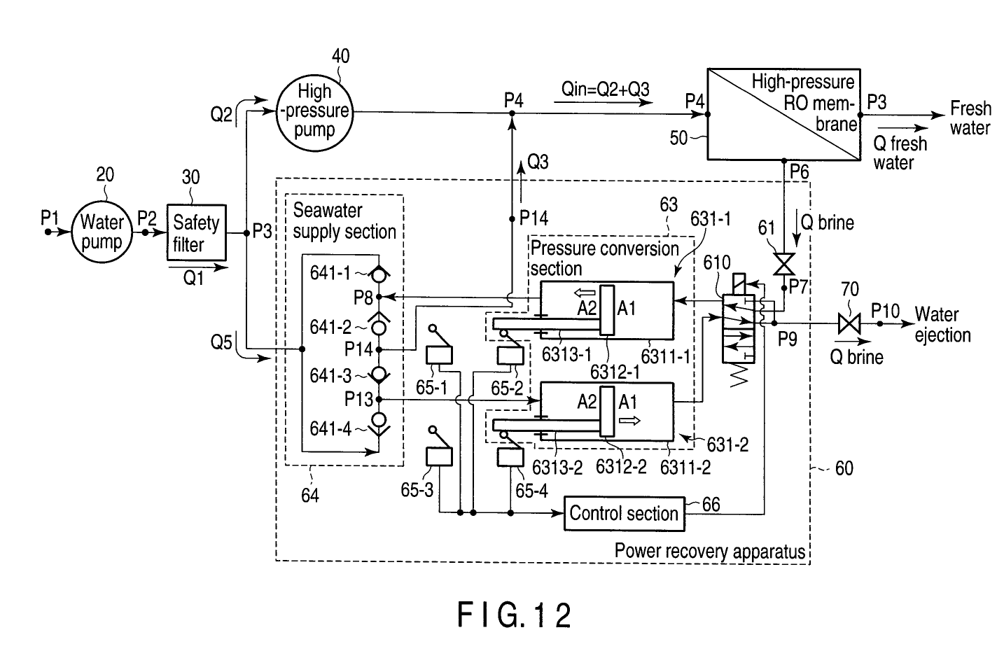

Although the first embodiment has been described with reference to an example in which the power recovery apparatus 60 includes the 4-port switch valve 62, a 5-port switch valve 610 may be used in place of the 4-port switch valve 62, as represented in FIG. 12.

Also, the first embodiment has been described with reference to an example in which two converters 631-1 and 631-2 are mounted on the power recovery apparatus 60. However, 2n converters (where n is an natural number) may be mounted.

### Second Embodiment

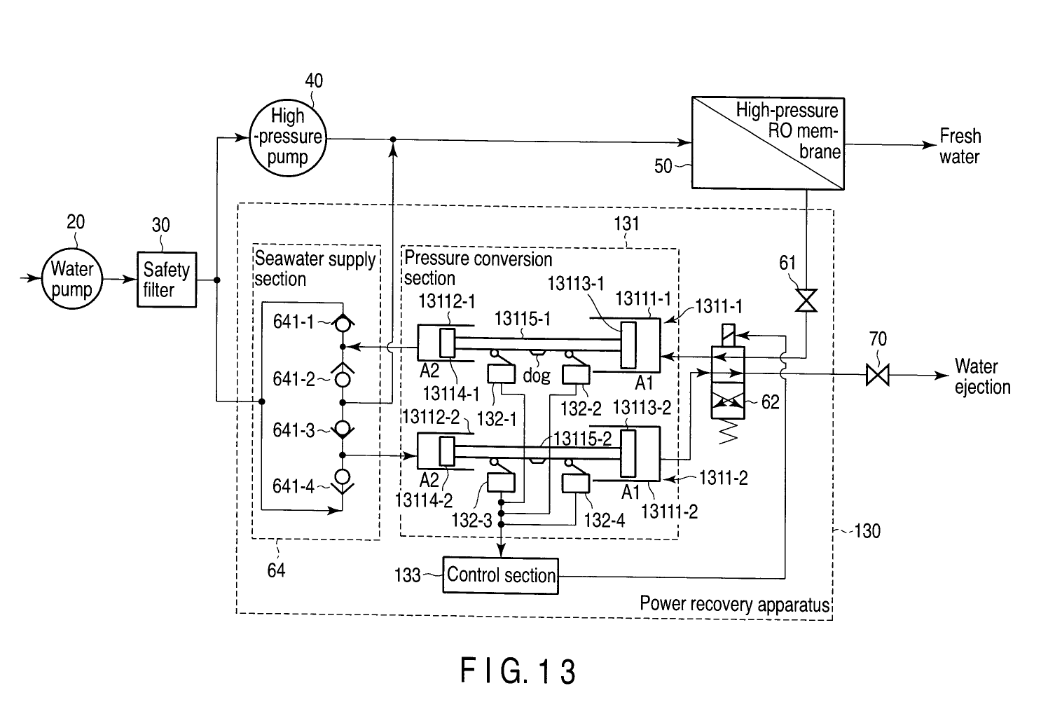

FIG. 13 is a block diagram representing a configuration of a power recovery apparatus 130 according to the second embodiment. Parts in FIG. 13 which are common to FIG. 2 will be denoted at common reference symbols, respectively, and only different parts will be described herein.

A pressure conversion section 131 in the power recovery apparatus 130 includes converters 1311-1 and 1311-2. The converters 1311-1 and 1311-2 have the same structures as each other, and therefore, only the converter 1311-1 will be described herein.

The converter 1311-1 includes cylinders 13111-1 and 13112-1, pistons 13113-1 and 13114-1, and a connection rod 13115-1.

The cylinder 13111-1 has an open surface, and another surface where a hole is provided. Further, an inside area of a cross-section vertical to a lengthwise direction of the cylinder 13111-1 is A1. Further, the cylinder 13112-1 has an open surface, and another surface where a hole is provided. Further, an inside area of a cross-section vertical to a lengthwise direction of the cylinder 13112-1 is A2. Open surfaces of the cylinders 13111-1 and 13112-1 are opposed to each other.

The piston 13113-1 is positioned inside the cylinder 13111-1, and forms a first space, with a seal material provided between the piston 13113-1 and the cylinder 13111-1. The piston 13113-1 has an area A1. Further, the piston 13114-1 is positioned inside the cylinder 13112-1, and forms a second space, with a seal material provided between the piston 13114-1 and the cylinder 13112-1. The piston 13114-1 has an area A2. The first space is supplied with highly-concentrated salt water, and the second space is supplied with seawater. Here, a relationship between the areas A1 and A2 is preset on the basis of a pressure of highly-concentrated salt water from a high-pressure RO membrane 50, a pressure of seawater from a high pressure pump 40, friction between the cylinder 13111-1 and the piston 13113-1, and friction between the cylinder 13112-1 and the piston 13114-1.

The connection rod 13115-1 connects the pistons 13113-1 and 13114-1. A dog is formed at a predetermined position on the connection rod 13115-1.

Detection sections 132-1 and 132-2 are to detect positions of the dog. The detection section 132-1 is located at a position where contact with the dog can be detected when the piston 13114-1 comes close to the left end of the cylinder 13112-1. The detection section 132-2 is located at a position where contact with the dog can be detected when the piston 13113-1 comes close to the right end of the cylinder 13111-1. The detection sections 132-1 and 132-2 output detection signals to a control section 133 when the dog is detected. In this manner, the positions of the pistons 13113-1 and 13114-1 in the converter 1311-1 can be recognized. Further, detection sections 132-3 and 132-4 have the same configuration as the detection sections 132-1 and 132-2, and are to detect positions of the dog on the connection rod 13115-2. When the detection sections 132-3 and 132-4 detect the dog, the detection sections 132-3 and 132-4 output detection signals to the control section 133. In this manner, positions of the pistons 13113-2 and 13114-2 in the converter 1311-2 can be grasped.

The control section 133 outputs a switch instruction to a 4-port switch valve 62 in accordance with detection signals from the detection sections 132-1 to 132-4. That is, when the control section 133 receives detection signals from the detection sections 132-1 and 132-4, the switch control section 133 determines that the piston 13114-1 is positioned close to the left end of the cylinder 13112-1 and that the piston 13113-2 is positioned close to the right end of the cylinder 13111-2. Further, the control section 133 outputs a switch instruction to the 4-port switch valve 62 to make the converter 1311-1 eject highly-concentrated salt water and to make the converter 1311-2 be supplied with highly-concentrated salt water.

Otherwise, when the control section 133 receives detection signals from the detection sections 132-2 and 132-3, the control section 133 determines that the piston 13113-1 is positioned close to the right end of the cylinder 13111-1 and that the piston 13114-2 is positioned close to the left end of the cylinder 13112-2. Further, the control section 133 outputs a switch instruction to the 4-port switch valve 62 to make the converter 1311-1 be supplied with highly-concentrated salt water and to make the converter 1311-2 eject highly-concentrated salt water.

With the configuration as described above, the power recovery apparatus 130 according to the above second embodiment can achieve the same operation and effects as the power recovery apparatus 60 according to the first embodiment.

Also, the above second embodiment has been described with reference to an example in which two converters 1311-1 and 1311-2 are mounted on the power recovery apparatus 130. However, 2n converters (where n is an natural number) may be mounted.

### Third Embodiment

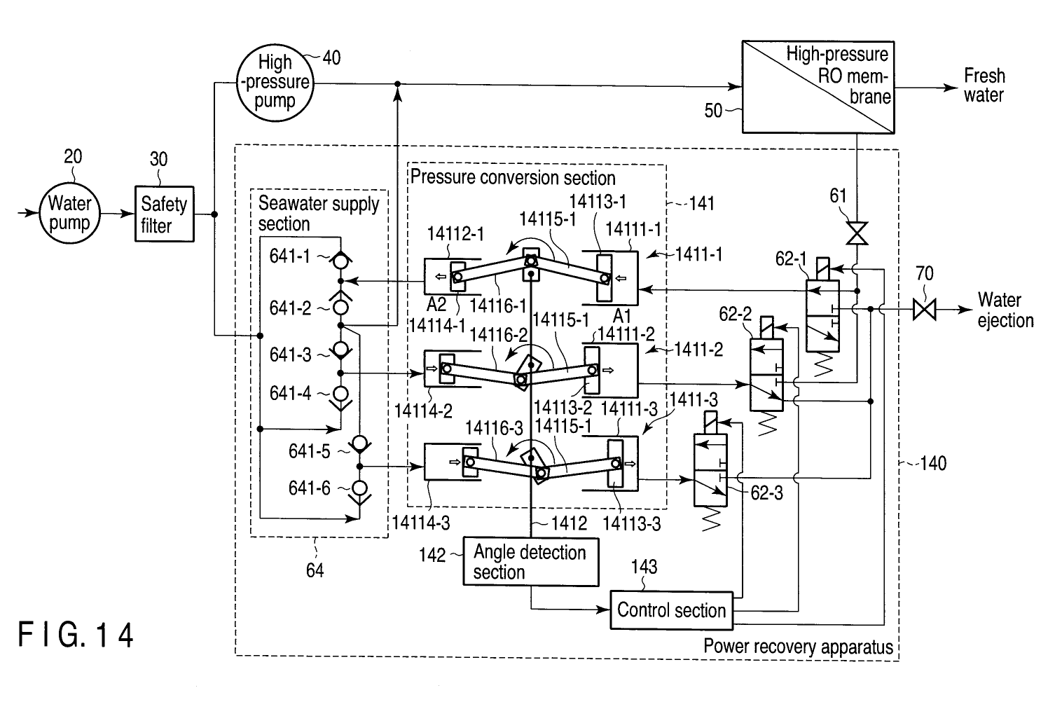

FIG. 14 is a block diagram representing a configuration of a power recovery apparatus 140 according to the third embodiment. Parts in FIG. 14 which are common to FIG. 2 will be denoted at common reference symbols, respectively, and only different parts will be described herein.

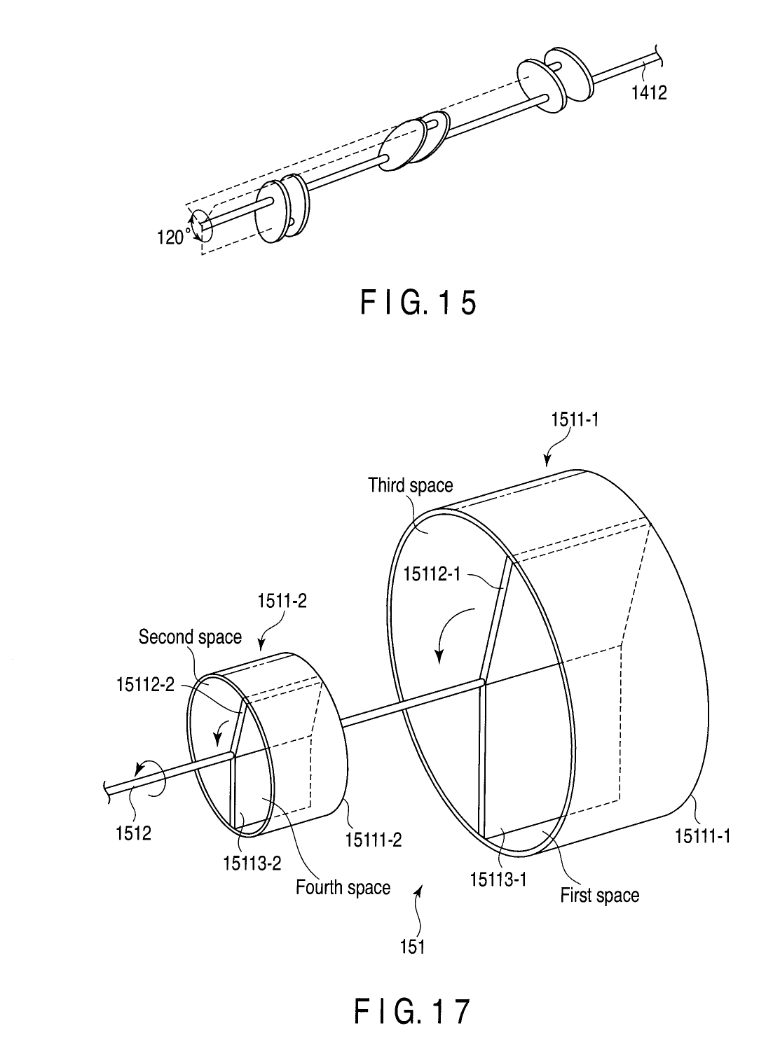

A pressure conversion section 141 in the power recovery apparatus 140 includes converters 1411-1, 1411-2, and 1411-3. The converters 1411-1, 1411-2, and 1411-3 each are connected to a crankshaft 1412. Arms of the crankshaft 1412 are designed to be arranged at angular intervals of 120 degrees between each other, as illustrated in FIG. 15. The converters 1411-1, 1411-2, and 1411-3 have the same structures as each other, and therefore, only the converter 1411-1 will be described herein.

The converter 1411-1 includes cylinders 14111-1 and 14112-1, pistons 14113-1 and 14114-1, and connection rods 14115-1 and 14116-1.

The cylinder 14111-1 has an open surface, and another surface where a hole is provided. Further, an inside area of a cross-section vertical to a lengthwise direction of the cylinder 14111-1 is A1. Further, the cylinder 14112-1 has an open surface and another surface where a hole is provided. Further, an inside area of a cross-section vertical to a lengthwise direction of the cylinder 14112-1 is A2. Open surfaces of the cylinders 14111-1 and 14112-1 are opposed to each other.

The piston 14113-1 is positioned inside the cylinder 14111-1 and forms a first space, with a seal material provided between the piston 14113-1 and the cylinder 14111-1. The piston 14113-1 has an area A1. Further, the piston 14114-1 is positioned inside the cylinder 14112-1 and forms a second space, with a seal material provided between the piston 14114-1 and the cylinder 14112-1. The piston 13114-1 has an area A2. The first space is supplied with highly-concentrated salt water, and the second space is supplied with seawater. Here, a relationship between the areas A1 and A2 is preset on the basis of a pressure of highly-concentrated salt water from a high-pressure RO membrane 50, a pressure of seawater from a high pressure pump 40, friction between the cylinder 14111-1 and the piston 14113-1, and friction between the cylinder 14112-1 and the piston 14114-1.

The connection rod 14115-1 connects the piston 14113-1 and a pin of the crankshaft 1412. The connection rod 14116-1 connects the piston 14114-1 and a pin of the crankshaft 1412.

In a state of FIG. 14, highly-concentrated salt water is made flow into the first space of the converter 1411-1, and the piston 14113-1 is moved in a leftward direction by the highly-concentrated salt water. Further, seawater is made flow into the second spaces of the converters 1411-2 and 1411-3, and the pistons 14113-2 and 14113-3 are moved in a rightward direction by the seawater. Accordingly, the crankshaft 1412 rotates in an arrow direction in FIG. 14.

An angle detection section 142 is to detect a rotation angle of the crankshaft 1412. When the rotation angle reaches a predetermined angle, the angle detection section 142 then outputs a detection signal to a control section 143. For example, total six angles are registered in advance in the angle detection section 142 as the predetermined angle. The six angles correspond to angles at which the pistons 14113-1 to 14113-3 come close to the right ends of the cylinders 14111-1 to 14111-3, and angles at which the pistons 14114-1 to 14114-3 come close to the left ends of the cylinders 14112-1 to 14112-3. When the rotation angle reaches any of the angles, the angle detection section 142 outputs a detection signal to the control section 143. In this manner, the control section 143 can grasp positions of the pistons in the converters.

When the control section 143 receives the detection signal from the angle detection section 142, the control section 143 issues a switch instruction to a 3-port valve among switch valves 62-1 to 62-3, which is connected to one of the converters corresponding to the detection signal.

Next, operation of the power recovery apparatus 140 configured as described above will be described.

The power recovery apparatus 140 in FIG. 14 is in a state in which the converter 1431-1 is supplied with highly-concentrated salt water while highly-concentrated salt water is ejected from the converters 1411-2 and 1411-3.

Seawater from a safety filter 30 is supplied to a high-pressure pump 40 at 0.2 MPa and is also supplied to the second spaces of the converters 1411-2 and 1411-3 through check valves 641-4 and 641-6.

Seawater which has been boosted to 6.0 MPa by the high-pressure pump 40 is merged with seawater from the power recovery apparatus 140, and is introduced into the high-pressure RO membrane 50. At this time, the seawater from the power recovery apparatus 140 has been ejected from the second space of the converter 1411-1 and passed through the check valve 641-2. The high-pressure RO membrane 50 outputs fresh water and highly-concentrated salt water.

The highly-concentrated salt water ejected from the high-pressure RO membrane 50 passes through the valve 61 and 3-port switch valve 62-1, and flows into the first space of the converter 1411-1. At this time, the second space of the converter 1411-1 is filled with seawater. Highly-concentrated salt water moves the piston 14113-1 in the cylinder 14111-1 in a leftward direction, and the piston 14114-1 in the cylinder 14112-1 in a leftward direction. In this manner, seawater in the second space of the converter 1411-1 is pressed and ejected. At this time, the piston 14113-1 moves in the leftward direction, thereby applying torque to the crankshaft 1412 in a direction denoted in FIG. 14.

The piston 14113-1 has an area A1, and the piston 14114-1 has an area A2. Thus, a pressure of seawater which is ejected from the second space of the converter 1411-1 is expressed as P*(A1/A2), using a pressure P of highly-concentrated salt water from the 3-port switch valve 62-1. Accordingly, the pressure of seawater ejected from the second space of the converter 1411-1 is equal to or slightly higher than a pressure of seawater supplied to the high-pressure RO membrane 50.

When the crankshaft 1412 rotates in the arrow direction in FIG. 14, the pistons 14113-2, 14113-3, 14114-2, and 14114-3 of the converters 1411-2 and 1411-3 connected to the crankshaft 1412 move in rightward directions. Accordingly, seawater is made flow from the check valves 641-4 and 641-6 to each of the second spaces in the converters 1411-2 and 1411-3, and highly-concentrated salt water is ejected from each of the first spaces of the converters 1411-2 and 1411-3 through the 3-port switch valves 62-2 and 62-3 and the valve 70.

When the operation as described above is continued, a detection signal is output from the angle detection section 142 to the control section 143 each time when the rotation angle of the crankshaft 1412 reaches the predetermined angle. The control section 143 receives the detection signal from the angle detection section 142, and then switches the 3-port switch valves 62-1 to 62-3 successively so as to switch directions of flow-in and ejection of highly-concentrated salt water.

With the configuration as described above, the power recovery apparatus 140 according to the above third embodiment can achieve the same operation and effects as the power recovery apparatus 60 according to the first embodiment.

Further, in the third embodiment, the pistons are connected to the crankshaft 1412. Therefore, displacements in lengthwise directions of the pistons transit like a sine curve. Further, the 3-port switch valves 62-1 to 62-3 switch directions of flow-in and ejection of highly-concentrated salt water corresponding to positions of the pistons in the cylinders. In this manner, pulsation which takes place when the 3-port switch valves 62-1 to 62-3 switch directions of flow-in and ejection is reduced.

The above third embodiment has been described with reference to an example in which three converters 14111-1 to 14111-3 are mounted on the power recovery apparatus 140. However, 3n converters (where n is an natural number) may be mounted.

### Fourth Embodiment

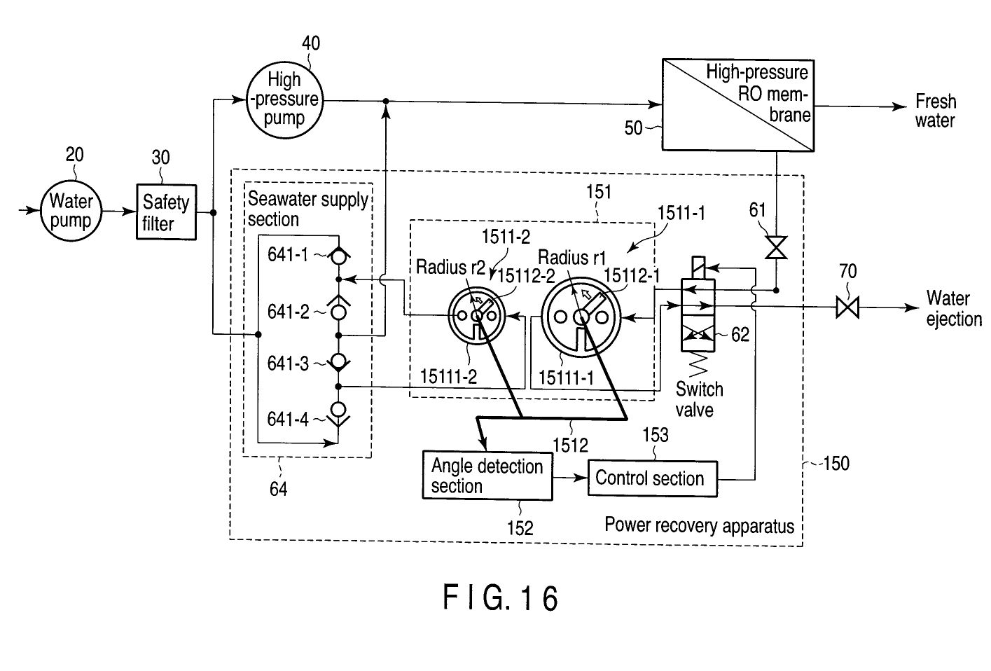

FIG. 16 is a block diagram representing a configuration of a power recovery apparatus 150 according to the fourth embodiment. Parts in FIG. 16 which are common to FIG. 2 will be denoted at common reference symbols, respectively, and only different parts will be described herein.

A pressure conversion section 151 in the power recovery apparatus 150 includes vane-type rotary actuators 1511-1 and 1511-2. FIG. 17 is a schematic view illustrating a structure of the rotary actuators 1511-1 and 1511-2 according to the fourth embodiment.

In FIG. 17, the rotary actuators 1511-1 and 1511-2 are connected by a rotary shaft 1512.

The rotary actuator 1511-1 includes a housing 15111-1 and a vane 15112-1. The housing 15111-1 forms a sealed space and has a cylindrical shape having a radius r1. The rotary shaft 1512 is located so as to penetrate the housing 15111-1 along a center axis thereof. A screen part 15113-1 is formed to extend from an inner wall surface of the housing 15111-1 to the rotary shaft 1512. The screen part 15113-1 is fixed inside the housing 15111-1.

The vane 15112-1 is formed to be connected with the rotary shaft 1512, and makes contact with the inner wall surface of the housing 15111-1 through a sealing agent. The vane 15112-1 has an area A1.

A sealed space formed by the housing 15111-1 is divided into first and third spaces by the vane 15112-1 and the screen part 15113-1. When highly-concentrated salt water is made flow into the first space, the vane 15112-1 rotates in an arrow direction illustrated in FIG. 17, and pushes and ejects highly-concentrated salt water filled in the third space. Inversely, when highly-concentrated salt water is made flow into the third space, the vane 15112-1 rotates in a direction opposite to the arrow direction in FIG. 17, and pushes and ejects highly-concentrated salt water filled in the first space.

The rotary actuator 1511-2 includes a housing 15111-2 and a vane 15112-2. The housing 15111-2 forms a sealed space and has a cylindrical shape having a radius r2. A relationship of radius r1>radius r2 is given. The rotary shaft 1512 is located so as to penetrate the housing 15111-2 along a center axis thereof. A screen part 15113-2 is formed to extend from an inner wall surface of the housing 15111-2 to the rotary shaft 1512. The screen part 15113-2 is fixed inside the housing 15111-2.

The vane 15112-2 is formed to be connected with the rotary shaft 1512, and makes contact with the inner wall surface of the housing 15111-2 through a sealing agent. The vanes 15112-1 and 15112-2 maintain a same angle each other.

The vane 15112-2 has an area A2. Here, a relationship between the areas A1 and A2 is preset on the basis of a pressure of highly-concentrated salt water from a high-pressure RO membrane 50, a pressure of seawater from a high pressure pump 40, friction between the housings 15111-1 and 15111-2 and the vanes 15112-1 and 15112-2.

A sealed space formed by the housing 15111-2 is divided into second and fourth spaces by the vane 15112-2 and the screen part 15113-2. When seawater is made flow into the fourth space, the vane 15112-2 rotates in an arrow direction illustrated in FIG. 17, and pushes and ejects seawater filled in the second space. Inversely, when seawater is made flow into the second space, the vane 15112-2 rotates in a direction opposite to the arrow direction in FIG. 17, and pushes and ejects seawater filled in the fourth space.

An angle detection section 152 is to detect a rotation angle of the rotary shaft 1512. When the rotation angle reaches a predetermined angle, the angle detection section 152 outputs a detection signal to a control section 153. For example, two angles are registered in advance in the angle detection section 152 as the predetermined angle. One is an angle at which the vane 15112-1 and 15112-2 respectively come close to the screen part 15113-1 and 15113-2 from left sides. Another one is an angle at which the vanes 15112-1 and 15112-2 respectively come close to the screen parts 15113-1 and 15113-2 from right sides. When the rotation angle reaches any of the angles, the angle detection section 152 outputs detection signals to the control section 153. In this manner, the positions of the vanes 15112-1 and 15112-2 in the rotary actuators 1511-1 and 1511-2 can be recognized.

When the control section 153 receives the detection signal from the angle detection section 152, the control section 153 issues a switch instruction to a 4-port switch valve 62 so as to switch over the spaces into and from which highly-concentrated salt water is made flow and eject, respectively.

Next, operation of the power recovery apparatus 150 configured as described above will be described.

The power recovery apparatus 150 in FIG. 16 is in a state in which highly-concentrated salt water is supplied to the first space in the rotary actuator 1511-1 and highly-concentrated salt water is ejected from the third space of the rotary actuator 1511-1.

Seawater from a safety filter 30 is supplied to a high-pressure pump 40 at 0.2 MPa and is also supplied to the fourth space of the rotary actuator 1511-2 through a check valve 641-4.

Seawater which has been boosted to 6.0 MPa by the high-pressure pump 40 is merged with seawater from the power recovery apparatus 150, and is supplied to the high-pressure RO membrane 50. At this time, the seawater from the power recovery apparatus 150 has been ejected from the second space of the rotary actuator 1511-2 and passed through the check valve 641-2. The high-pressure RO membrane 50 outputs fresh water and highly-concentrated salt water.

The highly-concentrated salt water ejected from the high-pressure RO membrane 50 passes through the valve 61 and 4-port switch valve 62 and flows into the first space of the rotary actuator 1511-1. At this time, the third space of the rotary actuator 1511-1 is filled with highly-concentrated salt water. Highly-concentrated salt water rotates the vane 15112-1 in the rotary actuator 1511-1 in a direction toward the third space, and ejects highly-concentrated salt water in the third space through the 4-port switch valve 62 and valve 70.

When the vane 15112-1 of the rotary actuator 1511-1 rotates, the vane 15112-2 of the rotary actuator 1511-2 connected by the rotary shaft 1512 rotates accordingly. Therefore, seawater is ejected from the second space of the rotary actuator 1511-2 through the check valve 641-2, and seawater is made flow into the fourth space of the rotary actuator 1511-2 through the check valve 641-4.

Here, the vane 15112-1 has an area A1, and the vane 15112-2 has an area A2. Thus, a pressure of seawater ejected from the second space of the rotary actuator 1511-2 is (A1/A2) times higher than that of highly-concentrated salt water from the 4-port switch valve 62. Therefore, a pressure of seawater ejected from the second space of the rotary actuator 1511-2 is equal to or slightly higher than a pressure of seawater supplied to the high-pressure RO membrane 50.

When the operation as described above is continued, the vanes 15112-1 and 15112-2 respectively come close to the screen parts 15113-1 and 15113-2 from left sides. Then, the angle detection section 152 detects the predetermined angle to be reached, and outputs the detection signal to the control section 153. The control section 153 receives the detection signal from the angle detection section 152, and then issues a switch instruction to the 4-port switch valve 62 so as to switch directions of flow-in and ejection of highly-concentrated salt water.

With the configuration as described above, the power recovery apparatus 150 according to the above fourth embodiment can achieve the same operation and effects as the power recovery apparatus 60 according to the first embodiment.

The above fourth embodiment has been described with reference to an example in which the pressure converter 151 includes the vane-type rotary actuators 1511-1 and 1511-2. However, the present embodiment is not limited to this example. For example, the fourth embodiment is practicable even when a gear motor, an axial piston motor, a plunger pump, a radial piston motor, and a trochoid motor is included in place of the vane-type rotary actuators.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power recovery apparatus used in a desalination apparatus in which a first pressure of seawater is boosted to a second pressure by a high-pressure pump and supplied to a reverse osmosis membrane, the reverse osmosis membrane extracting fresh water from the seawater and ejecting concentrated water at a third pressure, the power recovery apparatus collecting energy of the concentrated water, the power recovery apparatus comprising:
a pressure conversion section which comprises a movable part dividing inside of the conversion section into first and second spaces, moves the movable part by causing the first space to receive the concentrated water at the third pressure from the reverse osmosis membrane, and pushes out seawater filled in the second space, in accordance with movement of the movable part, to output the seawater at the second pressure; and
a seawater supply section which merges the seawater from the pressure conversion section with the seawater from the high-pressure pump.

2. The power recovery apparatus of claim 1, further comprising:
a switch section which switches whether to supply the concentrated water at the third pressure from the reverse osmosis membrane to the first space or to eject concentrated water filled in the first space;
a detection section which detects a position of the movable part in the pressure conversion section; and
a control section which gives a first switch instruction to the switch section so as to eject the concentrated water filled in the first space if the detection section detects the movable part to be at a position where the second space is narrowed by a preset volume, or gives a second instruction to the switch section so as to supply the concentrated water to the first space if the detection section detects the movable part to be at a position where the first space is narrowed by a preset volume, wherein
the seawater supply section supplies the seawater at the first pressure to the second space if the concentrated water filled in the first space is ejected from the first space, and
the pressure conversion section moves the movable part by causing the second space to receive the seawater at the first pressure from the seawater supply section, and ejects the concentrated water filled in the first space through the switch section, in accordance with movement of the movable part.

3. The power recovery apparatus of claim 2, wherein
the pressure conversion section comprises at least two converters each of which is alternately switched to supply and eject the concentrated water by the switch section,
each of the converters comprises
a cylinder which includes a hole and forms a sealed space,
a piston which is provided as the movable part in the cylinder and divides the sealed space into the first and second spaces, and
a rod which has an end being bonded to the piston from a side of the second space, and another end forming a protruding part protruding to outside through the hole,
the seawater supply section merges the seawater from one of the second spaces of the converters with the seawater from the high-pressure pump, and supplies the seawater at the first pressure to the other one of the second spaces,
the detection section detects the position of the piston by detecting the protruding part, and
the control section gives the first or second switch instruction to the switch section, based on the position of the piston.

4. The power recovery apparatus of claim 3, wherein an area of the piston in a side of the first space is greater than another area of the piston in the side of the second space by a cross-sectional area of the shaft.

5. The power recovery apparatus of claim 2, wherein
the pressure conversion section comprises at least two converters each of which is alternately switched to supply and eject the concentrated water by the switch section
each of the converters comprises
first and second cylinders which have an open surface and a closed surface,
a first piston which is provided in the first cylinder, and forms the first space in the first cylinder,
a second piston which is provided in the second cylinder, and forms the second space in the second cylinder,
a connection rod which has a dog at a predetermined position, the connection rod connecting the first and second pistons, thereby forming the movable part,
wherein
the seawater supply section merges the seawater from one of the second spaces of the converters with the seawater from the high-pressure pump, and supplies the seawater at the first pressure to the other one of the second spaces,
the detection section detects positions of the first and second pistons by detecting the dog, and
the control section gives the first or second switch instruction to the switch section, based on the positions of the first and second pistons.

6. The power recovery apparatus of claim 5, wherein
the first cylinder has a greater diameter than the second cylinder, and
the first piston has a larger area than the second piston.

7. The power recovery apparatus of claim 2, wherein
the pressure conversion section comprises at least three converters which are successively switched whether to supply or eject the concentrated water, by the switch section,
the converters are connected to arms formed on a crankshaft at interval angles of 120 degrees between each other, each of the converters comprises
first and second cylinders which have an open surface and a closed surface,
a first piston which is provided in the first cylinder, and forms the first space in the first cylinder,
a second piston which is provided in the second cylinder, and forms the second space in the second cylinder,
a first connection rod which connects one of the arms with the first piston,
a second connection rod which connects the arm with the second piston,
the first and second pistons and the first and second connection rods are connected to the arms, thereby forming the movable part,
the seawater supply section merges the seawater from at least one of the second spaces of the converters with the seawater from the high-pressure pump, and supplies the seawater at the first pressure to other second spaces,
the detection section detects positions of the first and second pistons for each of the converters, by detecting a rotation angle of the crankshaft,
the control section successively gives the first or second switch instruction to the switch section, based on the positions of the first and second pistons for each of the converters.

8. The power recovery apparatus of claim 7, wherein
the first cylinder has a greater diameter than the second cylinder, and
the first piston has a larger area than the second piston.

9. The power recovery apparatus of claim 1, wherein
the pressure conversion section comprises first and second vane-type rotary actuators connected by one identical rotary shaft,
the first rotary actuator comprises
a first housing which forms a first sealed space filled with the concentrated water and internally comprises a first screen part, and
a first vane which is provided on the rotary shaft in the first housing and divides, in cooperation with the first screen part, the first sealed space into two spaces, the two spaces corresponding to the first space and a third space,
the second rotary actuator comprises,
a second housing which forms a second sealed space filled with the seawater and internally comprises a second screen part, and
a second vane which is provided on the rotary shaft in the second housing, and divides, in cooperation with the second screen part, the second sealed space into two spaces, the two spaces corresponding to the second space and a fourth space,
the first and second vanes rotate with a same angle each other, and forms, in cooperation with the rotary shaft, the movable part, and

10. The power recovery apparatus of claim 9, further comprising:
a switch section which switches whether to supply concentrated water at the third pressure from the reverse osmosis membrane to the first space or the third space;
a detection section which detects positions of the first and second vanes by detecting a rotation angle of the rotary shaft; and
a control section which gives a first switch instruction to the switch section so as to supply the concentrated water to the third space if the detection section detects the first vane to be at a position where the third space is narrowed by a preset volume, or gives a second instruction to the switch section so as to supply the concentrated water to the first space if the detection section detects the first vane to be at a position where the first space is narrowed by a preset volume, wherein
the pressure conversion section pushes and ejects concentrated water filled in the third space by the first vane and accordingly ejects seawater filled in the second space at the second pressure by the second vane, if the concentrated water is supplied to the first space, or pushes and ejects concentrated water filled in the first space by the first vane and accordingly seawater filled in the fourth space at the second pressure by the second vane, if the concentrated water is supplied to the third space, and
the seawater supply section supplies the seawater at the first pressure to the fourth space if the concentrated water is supplied to the first space, or supplies the seawater at the first pressure to the second space if the concentrated water is supplied to the third space.

11. The power recovery apparatus of claim 10, wherein the first vane has an larger area than the second vane.

12. The power recovery apparatus of claim 1, further comprising a valve which adjusts a pressure of the concentrated water supplied to the pressure conversion section from the reverse osmosis membrane.
